(19) United States
(12) Patent Application Publication
(10) Pub. No.: US 2006/0254398 A1
(43) Pub. Date: Nov. 16, 2006

(54) Removable/replaceable handle device

(75) Inventor: John H. Ward, Spencer, IN (US)

Correspondence Address: BRINKS HOFER GILSON & LIONE, P.O. BOX 10395, CHICAGO, IL, 60610, US

(73) Assignee: Vance Products Inc., d/b/a Cook Urological Inc., Spencer, IN (US)

(21) Appl. No.: 11/430,380

(22) Filed: May 8, 2006

Related U.S. Application Data
(60) Provisional application No. 60/679,907, filed on May 11, 2005.

(51) Int. Cl. B25H 3/00

(52) U.S. Cl. 81/487

(57) ABSTRACT

A handle is provided that can removeably support a medical device. The handle features a grip with a cavity that communicates with the environment outside the grip through two apertures. A compressed flat spring is inserted into the cavity and can be operated by the user to position the spring into one of two positions. The spring contains at least one aperture through which a portion of the medical device is inserted. The medical device is rigidly held within the grip when the spring is in the first position and is removable when the spring is in the second position.

### CROSS REFERENCE TO RELATED APPLICATIONS

This application claims priority from provisional application Ser. No. 60/679,907, filed on May 11, 2005.

### BACKGROUND

This invention relates to medical devices, and specifically structures to facilitate the use of a medical device in a medical situation. The use of medical devices often requires extreme precision in the administration or placement of the medical device in order to ensure that the device functions properly and in the intended area of the patient. Additionally, because some devices, such as needles, are designed to apply a fluid through a barrier, there are many hazards associated with operating the medical device differently from the intended manner. For example, medical practitioners are sometimes punctured with needles that are being used in a medical application, which may causes the injection of fluids into the medical professional that were designed for use with the patient and may be harmful to the medical professional. Compounding this problem is the fact that many medical devices are very small and are manufactured with a structure that is not easily operated precisely with the dexterity of the average medical professional. Also, it is difficult to design and manufacture the medical device with a structure that can be precisely manipulated by a medical professional.

### BRIEF SUMMARY

The present invention solves one or more of the shortcomings above by providing a handle that securely but releasably holds a medical device, giving the medical professional a more ergonomic structure to hold the device and therefore allowing the medical professional to apply or administer the device with greater precision.

Accordingly, a handle is provided that can accept a portion of a medical device, securely hold the device within the handle, and release the device for use with a patient when desired. The handle includes a grip having a cavity that communicates with the environment through two apertures in the exterior surface of the grip. A spring is compressed and inserted into a first portion of the cavity and can be operated by the user to transfer the spring between two positions. A proximal portion of the medical device is inserted into the cavity and extends through at least one aperture in the spring. When the spring is in the first position, it rigidly maintains a proximal portion of the medical device within the grip and when the spring is transferred to the second position, the user may withdraw the medical device from the grip.

A first preferred embodiment includes an apparatus for removeably holding a medical device comprising a grip having a cavity and two apertures and a spring disposed in a compressed state in the cavity, wherein the spring has a first position to retain a medical device inserted in the cavity and a second position to release the medical device inserted in the cavity.

A second preferred embodiment includes a grip for removeably supporting a medical device that comprises a generally cylindrical structure, wherein the structure includes a cavity, and a first and a second aperture forming an exit from the second cavity; and a spring disposed in the cavity in a compressed state, wherein the spring has a first position to retain a medical device inserted into the cavity and a second position to release the device from the cavity

A third preferred embodiment includes an apparatus for removeably supporting a medical device that comprises a grip formed as a generally cylindrical structure, wherein the grip includes a cavity formed therein, the grip having a first aperture forming an exit from the cavity and a second aperture forming an exit from the cavity; and a spring disposed in the cavity in a compressed state, the spring having a first end retained in the cavity and a second end extending through the first aperture, the spring having a first position to retain a medical device inserted into the cavity in the grip and a second position to allow the medical device inserted into the cavity to be released from the grip, the second end of the spring further comprising a button to allow the user to transfer the spring from the first position to the second position, wherein the medical device is inserted through at least one aperture in the spring and held in the grip when the spring is in the first position by a top surface of the at least one aperture contacting a surface of the medical device.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of one embodiment of a handle device;

FIG. 2 is a cross-sectional view of the handle device of FIG. 1;

FIG. 3 is a top view of the spring of the handle device of FIG. 1;

FIG. 4 is a detailed view of FIG. 2 magnified about region A showing the spring in a first position;

FIG. 5 is a detailed view of FIG. 2 magnified about region A showing the spring in a second position;

FIG. 6 is a detailed view of FIG. 2 magnified about region A showing an alternate embodiment of the medical device; and

FIG. 7 is a cross-sectional view of a second embodiment of a handle device.

FIG. 8 is a detailed view of FIG. 2 magnified about region A showing a third embodiment of the handle device.

### DETAILED DESCRIPTION OF THE DRAWINGS AND THE PREFERRED EMBODIMENTS

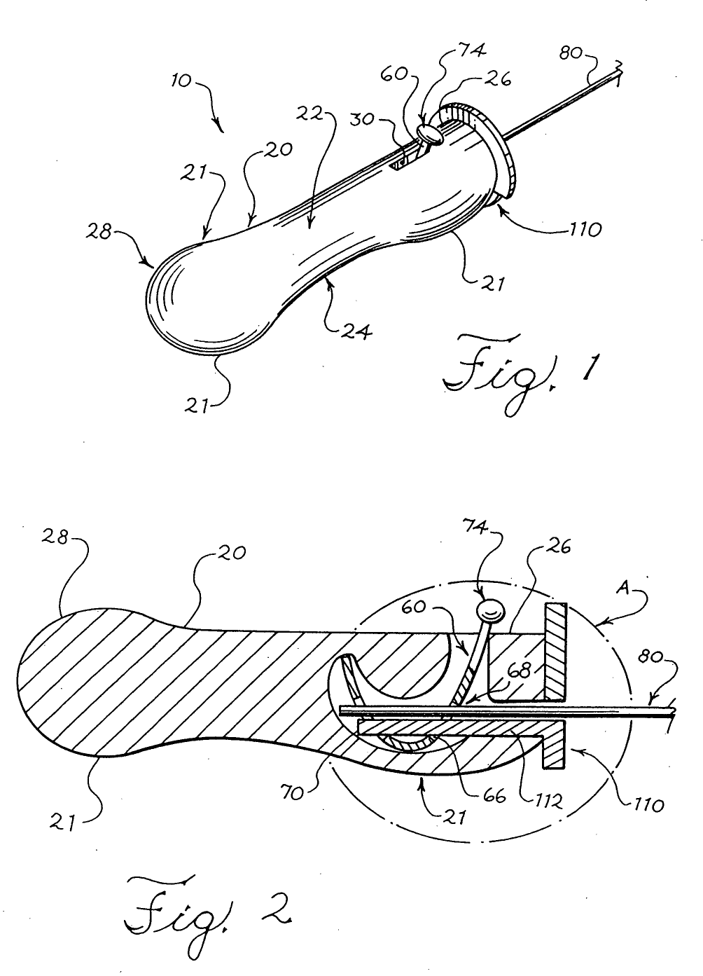

With reference to FIG. 1, a handle 10 for supporting a medical device 80 is provided. Handle 10 can be used with a variety of medical devices that have a straight and thin proximal end, for example, ligature carriers, stone retrievers, stylet and needle shafts, probes, etc. The embodiments herein specifically describe and illustrate the use of the handle 10 for use with a medical device 80, but handle 10 may also be fitted to incorporate other types of devices that include a straight and thin end capable of being manipulated by the handle 10 as designed and described herein.

As shown in FIG. 1, handle 10 includes a grip 20, a spring 60, a table 110, and a medical device 80. Grip 20 is generally cylindrically shaped and sized to be comfortably and securely held in one human hand. Grip 20 is preferably formed with a plurality of bumps or protrusions 21 on the exterior surface to ergonomically fit within the user's hand. Grip 20 contains a top surface 22, a bottom surface 24, a front end 26, and a rear end 28.

Grip 20 may be formed from a single molded piece of plastic, or can be formed of two oppositely molded clamshell halves that are attached together by snap fit connections, screws or similar fasteners known in the art, or glue or similar adhesives known in the art. Grip 20 and table 110 are preferably manufactured from ABS. ABS is a preferable material for manufacturing grip 20 and table 110 because of its ease and low cost of manufacturing and its aesthetic appearance as a final molded product. Additionally, there is a significant amount of compatibility data that has been compiled showing the safe use of ABS in medical applications with humans and animals. In addition to ABS, grip 20 and table 110 can be manufactured from nylon, polycarbonate, or any other plastic that can be molded into the desired shape with sufficient strength. In other embodiments, grip 20 and table 110 could also be manufactured from steel or other metals.

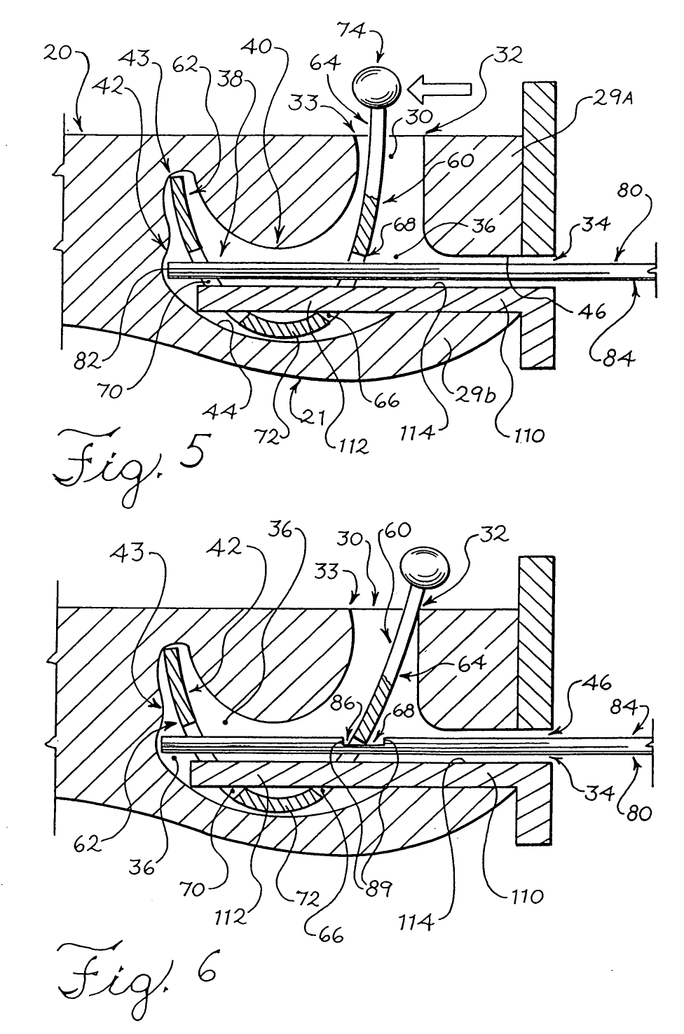

As best seen in FIGS. 4 and 5, grip 20 is formed with a cavity 36 inside a portion of the volume of grip 20. Cavity 36 has two portions, a first portion 38 and a second portion 46. First portion 38 is generally “U-shaped” and communicates with the environment outside grip 20 through a first aperture 30 located on the top surface 22 of grip 20. Grip 20 forms a ridge 40 separating the two legs of the “U” and a bottom surface 44 that forms the bottom portion of the “U.” First portion 38 is slightly wider than the width of spring 60. Grip 20 can be formed in different sizes to incorporate different size medical devices along with the use of different sized springs 60. As a result, the width of first portion 38 will vary with these parameters.

Additionally, the height of first portion 38 of cavity 36 is sized in order to retain the spring 60 in a compressed state (shown in FIGS. 4 and 5) within the volume of first portion 38 (discussed in detail below) with sufficient material above and below first portion 38 to ensure that grip 20 has sufficient strength to maintain its shape and structural integrity when subjected to expected loads, such as the pressure of being gripped and squeezed by the user's hand. The amount of material required between first portion 38 and the exterior surfaces of grip 20 will vary based on the strength of the material used.

The cavity 36 also includes a second portion 46. Second portion 46 of cavity 36 communicates with the environment outside grip 20 through a second aperture 34 that extends through front end 26 of grip 20. The second portion 46 is surrounded by an upper ledge 29a and a lower ledge 29b of the grip 20. Second portion 46 of cavity 36 extends from second aperture 34 towards rear end 28 of grip 20 and eventually combines with the volume of first portion 38. Second portion 46 is sized to allow the leg portion 112 of table 110 to extend therethrough as well as the diameter of the largest medical device 80 that is planned to be used with grip 20. The grip 20 will normally be used with medical devices with proximal end 82 diameters between 3 and 6 french. Additionally, second portion 46 extends through first portion 38 towards rear end 28 of grip 20 such that a proximal end 82 of a medical device 80 can extend all the way to the wall forming an enclosed end 42 of the “U-shaped” first portion 38 of cavity 36.

Grip 20 extends rearward of first portion 38 to form rear end 28. The length of grip 20 (i.e. distance from front end 26 to rear end 28) can be any length that is sufficient to accept and retain proximal end 82 of medical device 80 in grip 20 (as discussed below) and sufficiently sized to be held securely by the user's hand. Grip 20 may be formed of solid material between first portion 38 of cavity 36 and the rear end 28 of grip 20. Alternatively, grips formed with clamshell halves may be formed with a plurality of ribs or similar structures to ensure the grip 20 is strong enough based on the material chosen to not deform based on the anticipated stress applied by the user, but at the same time to minimize the amount of material used in forming grip 20 to minimize the weight of the handle 10 and material costs.

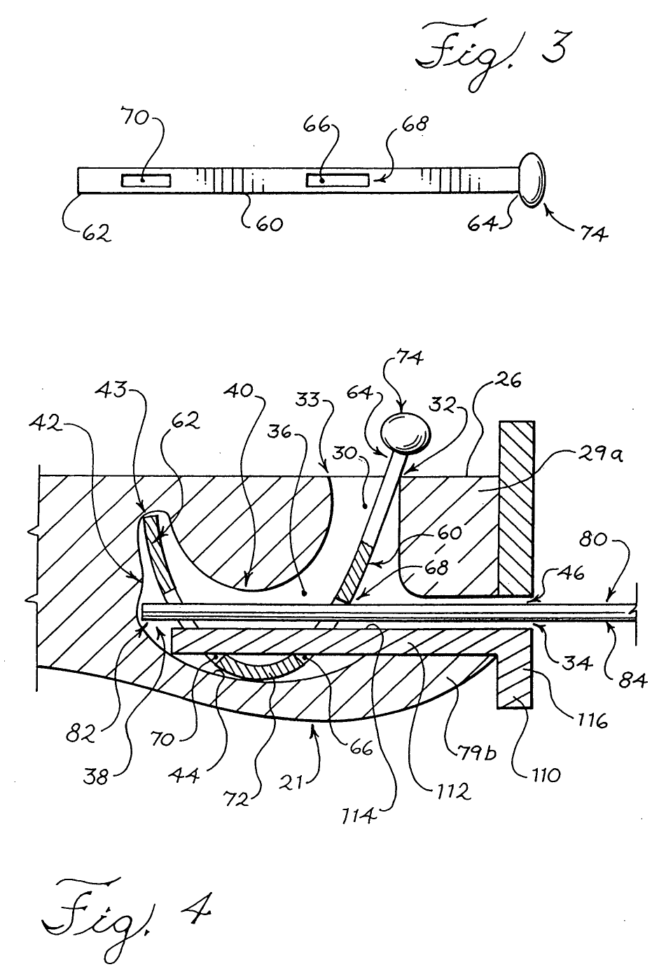

As best shown in FIG. 3, handle 10 also includes a spring 60, preferably formed as a flat spring, with a rectangular cross-section. Spring 60 is sized in order to provide the required strength and spring constant to allow spring 60 to work effectively with a large range of medical device 80 applications. Spring 60 includes a first end 62 and a second end 64. Spring 60 also includes first and second apertures 66, 70. Each of apertures 66, 70 preferably have a rectangular cross-section with a sufficient width to allow the width of proximal end 82 of the largest medical device 80 expected to be used with handle 10 to be inserted through apertures 66, 70. Preferably, both the internal and external corners of spring 60 are rounded for safety and to avoid stress concentration. Spring 60 must be wide enough to allow apertures 66, 70 of this width while retaining sufficient material outside apertures 66, 70 to prevent failure when spring 60 is compressed. It should be noted that spring 60 will be relatively flat at the location of each aperture 66, 70 so stresses felt at these locations due to spring compression will be less than stresses felt by the spring at a U-bend 72 section of spring 60.

First aperture 66 and second aperture 70 are sized to allow both the medical device 80 and the leg section 112 of table 110 to extend through each aperture. In addition, the first aperture 66 includes sufficient room to allow the spring 60 to be moved to allow the release of the medical device 80 as is discussed below.

In an alternative embodiment shown in FIG. 8, the second aperture 70 of the spring is sized and positioned on the spring to only allow leg section 112 of table 110 to extend through aperture 70. With this embodiment the medical device 80 can more easily be inserted into grip 20 because it only must extend through first aperture 66 and spring 60 need not be aligned within cavity 36 to allow proximal end 82 of medical device 80 to also extend through second aperture 70. Therefore, in this embodiment, proximal end 82 is supported by the top edge 68 of first aperture 66 and rests on top surface 114 of table 110. Other than the fact that proximal end 82 only extends through first aperture 66 of spring 60, the handle device 10 is operated in the same manner as discussed with the other embodiments disclosed in this specification.

When assembling handle 10, the spring 60 is compressed and inserted into first portion 38 of cavity 36 such that first end 62 of spring 60 is in enclosed end 42 of first portion 38 and second end 64 of spring 60 extends outside of grip 20 through first aperture 30. Spring 60 is retained inside grip 20 by ridge 40 extending below first end 62 of spring 60 to prevent it from being removed from grip 20. When compressed and inserted into first portion 38, spring 60 forms a “U-shape” roughly corresponding to the shape of first portion 38. A U-bend portion 72 of spring 60 contacts bottom surface 44 of the first portion 38 of cavity 36. Additionally, compressed spring 60 decompresses as much as possible inside first portion 38 and therefore first end 62 contacts rear surface 43 of enclosed end 42 of first cavity and spring 60 normally contacts front lip 32 of first aperture 30 near second end 64 of spring 60. Because the dimensions of first portion 38 prevent spring 60 from further straightening, spring 60 will remain in this orientation, i.e. the first position of spring 60, when not being manipulated by the user.

In other embodiments, the spring 60 can be initially manufactured as “U-shaped” rather than the preferred flat shape shown in FIG. 3. This may done when the size of medical device 80 to be used and the desired grip 20 size require wide apertures 66, 70 requiring correspondingly thick spring stock for sufficient strength. If spring 60 is sufficiently thick, it may provide too much resistance to bending to allow it to be formed as a flat piece, or leaf spring, to be sufficiently compressed to fit within first portion 38. In this case, spring 60 is manufactured already bent in a generally “U-shape” such that only nominal compression is required to install spring 60 into the first portion 38 of cavity 36. The use of spring 60 manufactured in a “U-shape” requires spring 60 to be somewhat compressed when assembled in cavity 36 to retain the proximal end 82 of medical device 80 when spring 60 is in the first, or normal, position (shown in FIG. 4).

Spring 60 is preferably manufactured from metal. The material for manufacturing spring 60 is chosen based on the type of medical device 80 to be used with handle 10. Spring 60 can be made from stainless steel for use with hard metal objects, such as needles, or softer materials for use with other types of medical devices 10, such as those manufactured with plastic or composite materials. Additionally, when the application warrants extra strength, the spring 60 may be heat treated or treated with any other process known in the art to manufacture a spring with extra strength.

Spring 60 further includes a button 74 that is fixed to the portion of the second end 64 of spring 60 extending outside of grip 20 through first aperture 30. Button 74 is preferably manufactured from molded plastic and joined to the second end 64 of spring 60. Alternatively, button 74 can be made from metal and formed with spring 60 during the manufacturing process.

Table 110 is also retained within handle 10. Table 110 includes a leg portion 112 and a front portion 116. The top surface 114 of leg portion 112 is flat and when inserted and retained within the cavity of grip 20, the leg portion 112 provides a surface to retain and support proximal end 82 of medical device 80 when it is inserted within grip 20. Leg portion 112 of table 110 extends through the first aperture 66 and the second aperture 70 of spring 60. This connection serves to retain spring 60 within cavity 36 when a medical device 80 is not inserted into grip 20.

Table 110 is retained within grip 20 by being affixed or mounted to the lower ledge 29b of grip 20. Table 110 can be mounted to lower ledge 29b with fasteners or adhesive or with other methods of connecting two components that are known in the art.

In operation, as shown in FIG. 4, proximal end 82 of a medical device 80 is retained by handle 10. Proximal end 82 enters the grip 20 through the second aperture 34, extends through the second portion of cavity 36 and enters first portion 38. Proximal end 82 is slid along top surface 114 of table 110 to support and direct the movement of medical device 80 when it is inserted into grip 20. Compressed spring 60 is retained in first portion 38 such that the proximal end 82 of medical device 80 extends through at least first aperture 66 of spring 60. Proximal end 82 can additionally extend further into first portion 38 of cavity 36 and extend through second aperture 70 of spring 60 in the disclosed embodiments where second aperture 70 is sized to accept proximal end 82 of medical device and leg section 112 of table 110. When spring 60 is in the first position (shown in FIG. 4) top edge 68 of first aperture 66 contacts a surface of proximal end 82 of medical device 80 forming a frictional connection between spring 60 and proximal end 82 due to the normal force of spring 60 felt on proximal end 82. This connection retains proximal end 82 inside grip 20. Because spring 60 is compressed in this position and forms a connection with the front lip 32 of grip 20, the connection between proximal end 82 and spring 60 is maintained even when the user does not operate grip 20.

It should be noted that in embodiments where proximal end 82 extends through second aperture 70 of spring 60, spring 60 does not serve to restrict movement of proximal end 82 within grip 20 with any connection between proximal end 82 and second aperture 70. Second aperture 70 is sized to allow proximal end 82 to extend through second aperture 70 simply to allow the length of distal end 84 extending outside of grip 20 to be fully adjustable, but not to aid in the retention of proximal end 82 of medical device 80 within grip 20.

To release proximal end 82 from grip 20, the user may hold grip 20 in one hand and operate spring 60 by moving button 74 on second end 64 of spring 60 with the user's thumb. Moving button 74 further compresses spring 60 such that it no longer contacts the front lip 32 of grip 20. Because first end 62 of spring 60 is in contact with the enclosed end 42 of cavity 36 when spring 60 is in the first position, the second end 64 of spring 60 will extend further through first aperture 30 when button 74 is moved toward the rear lip 33 of first aperture 30. Eventually, with sufficient compressive force applied to button 74, spring 60 will contact rear lip 33 of the first aperture 30. This is the second position of the spring as shown in FIG. 5, just before the spring 60 contacts the rear lip 33. To maintain spring 60 in this orientation, the user must continuously hold button 74.

As spring 60 is moved towards rear lip 33, the first aperture 66 of spring 60 moves upward toward the first aperture 30 of grip 20. As the first aperture 66 of spring 60 moves upward, its top edge 68 no longer contacts the proximal end 82 of medical device 80, which releases the frictional connection between spring 60 and proximal end 82 and allows medical device 80 to be slid outwards along tip surface 114 of table 110 and withdrawn from grip 20 through the second aperture 34 of grip 20. When button 74 is released spring 60 moves forward until it again contacts the front lip 32 of first aperture 30. If medical device 80 was not removed from grip 20, the top edge 68 of first aperture 66 will again contact proximal end 82 of medical device 80 and establish a frictional connection to retain proximal end 82 within grip 20.

As shown in FIG. 6, the proximal end 82 of medical device 80 can alternatively be formed with a notch 86 in the area that the top edge 68 of first aperture 66 of spring 60 will contact proximal end 82. This notch 86 will cause spring 60 to more securely hold proximal end 82 within grip 20 when spring 60 is in the first position (as shown in FIG. 6). With notch 86, proximal end 82 will only be maintained inside grip 20 based on the frictional connection between top edge 68 of first aperture 66 and proximal end 82, and walls 89 of notch 86 will contact spring 60 if the proximal end 82 of medical device 80 is moved further into grip 20 or further out of grip 20.

In a preferred embodiment, grip 20 will be sold along with medical device 80 and will not be reusable. Additionally, medical device 80 and grip 20 will be packaged and sold in a sterile condition to allow for use with humans or animals in medical environments.

For medical devices 80 with metal proximal ends 82, medical device 80 may be sold already inserted into handle device 20. For medical devices 80 with proximal ends 82 manufactured from of other materials, the medical device 80 may be sold along with grip 20, but not packaged with the medical device 80 inserted into grip 20. In these embodiments, the proximal end 82 of medical device 80 is inserted into grip 20 through the second aperture 34 of grip 20 and the second portion 46 of cavity 36 just before use by a medical professional. While inserting proximal end 82 into grip 20, along the top surface 114 of table 110, the user moves button 74 rearward until spring 60 contacts the rear lip 33 of first aperture 30. In this position, proximal end 82 can be inserted through the first aperture 66 (along with the second aperture 70, if desired) of spring 60. When proximal end 82 is fully inserted, the user releases button 74, which allows spring 60 to partially decompress until it contacts front lip 32. The top edge 68 of first aperture 66 of spring 60 will contact the surface of proximal end 82 establishing a frictional connection to retain the proximal end 82 of medical device 80 within the grip 20. If this process is used to insert medical device 80 into grip 20, the user must take precautions to ensure that medical device 80 and grip 20 are maintained sterile.

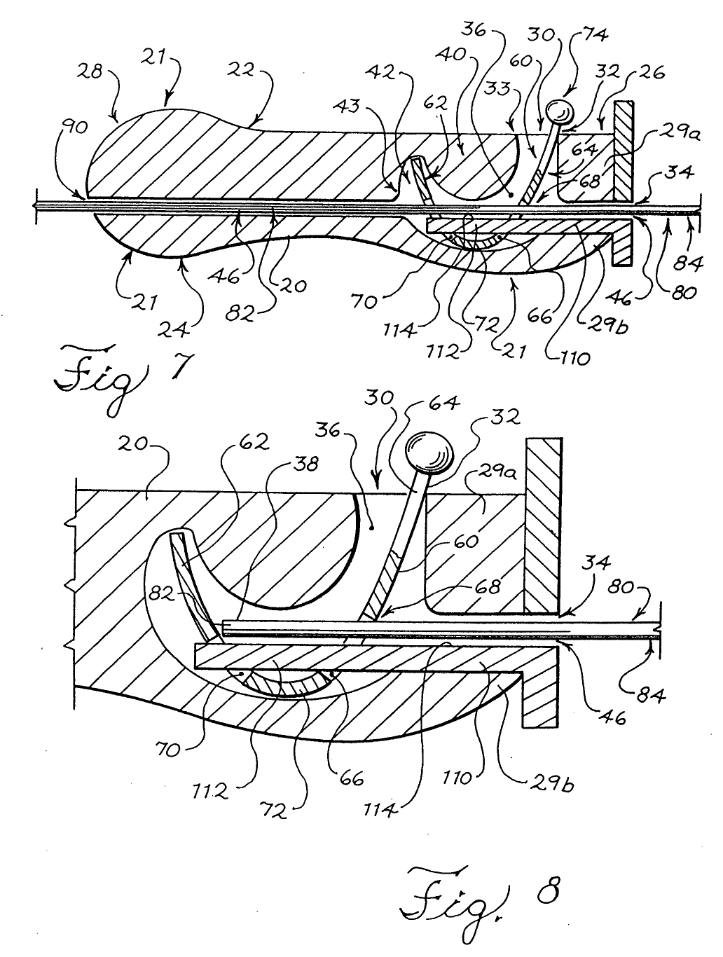

In a second preferred embodiment as is shown in FIG. 7, the handle 10 can be formed such that the proximal end 82 of medical device 80 can extend all the way through grip 20 such that a portion of proximal end 82 extends beyond the rear end 28 of grip 20. This embodiment allows the user to adjust the amount of distal end 84 of medical device 80 that extends beyond front end 26 and front end cap 27 of grip 20. The second embodiment is formed and operates in the same manner as the first embodiment described above with the exception that second portion 46 of cavity 36 extends throughout the length of grip 20 and exits grip 20 from a third aperture 90 at the rear end 28 of grip 20.

In operation, the user may adjust the length of distal end 84 of medical device 80 that extends from front end 26 of grip 20 using the following procedure. The user holds grip 20 in one hand and distal end 84 of medical device 80 in their opposite hand, ensuring that proper precautions are taken to ensure that medical device 80 and grip 20 remain sterile. The user moves button 74 towards the rear lip 33 of first aperture 30. This motion will cause spring 60 to move backward as well and cause the first aperture 66 of spring 60 to rise slightly toward the first aperture 30 of the grip 20. This motion will cause the top edge 68 of first aperture 66 to no longer contact the proximal end 82 of medical device 80 and will allow the user to adjust the position of medical device 80 with respect to grip 20 to change the length of distal end 84 extending from grip 20. When distal end 84 is in the desired position, the user releases button 74, which causes spring 60 to decompress until it contacts the front lip 32 of first aperture 30 of grip 20. When spring 60 contacts front lip 32, the top edge 68 of first aperture 68 of spring 60 will contact proximal end 82 of medical device 80, establishing the frictional connection between spring 60 and proximal end 82 to retain proximal end 82 within grip 20.

While the preferred embodiments of the invention have been described, it should be understood that the invention is not so limited and modifications may be made without departing from the invention. For instance, embodiments may include springs made from wire having a D-shaped cross-section, rather than a rectangular cross-section. The rounded portion of the wire may also act as a “button” or point where a user may easily actuate the spring to grip or release the medical device from the handle. The scope of the invention is defined by the appended claims, and all devices that come within the meaning of the claims, either literally or by equivalence, are intended to be embraced therein.

What is claimed is:

1. An apparatus for removeably holding a medical device, the apparatus comprising:
a grip, having a cavity and two apertures; and
a spring having a rectangular cross-section disposed in a compressed state in the cavity, wherein the spring has a first position to retain a medical device inserted in the cavity and a second position to release the medical device inserted in the cavity.

2. The apparatus of claim 1 wherein the spring further comprises a first end and a second end, the second end being operable to transfer the spring from the first position to the second position.

3. The apparatus of claim 2 wherein the second end of the spring extends through a first aperture of the grip.

4. The apparatus of claim 2 wherein the second end of the spring further comprises a button.

5. The apparatus of claim 1 further comprising the medical device inserted through at least one aperture in the spring and into a second aperture of the grip.

6. The apparatus of claim 5 wherein a top surface of the at least one aperture in the spring retains the medical device in the grip by contacting a surface of the medical device when the spring is in the first position.

7. The apparatus of claim 6 wherein the medical device further comprises a notch at the location where the top surface of the at least one aperture of the spring contacts the medical device.

8. The apparatus of claim 1 wherein the spring is a flat spring or a compressed flat spring.

9. The apparatus of claim 1 wherein the grip further comprises a pair of clamshell halves connected together.

10. The apparatus of claim 1 wherein the grip is a generally cylindrical structure sized to be operated by one hand, wherein the grip further comprises a plurality of protrusions.

11. A grip for removeably supporting a medical device the grip comprising:
a generally cylindrical member, wherein the member includes a cavity, and a first and a second aperture forming an exit from the cavity; and
a spring protracting from the cavity and disposed in the cavity in a compressed state, wherein the spring has a first position to retain a medical device inserted into the cavity and a second position to release the device from the cavity.

12. The grip of claim 11 wherein the spring further comprises a first end and a second end, the second end being operable to transfer the spring from the first position to the second position.

13. The grip of claim 12 wherein the second end of the spring extends through the first aperture of the grip.

14. The grip of claim 12 wherein the second end of the spring contains a button.

15. The grip of claim 11 wherein the grip can be held and operated with one hand.

16. The grip member of claim 11 wherein the medical device is inserted through at least one aperture in the spring when the spring is in either the first or the second position.

17. The grip member of claim 16 wherein a top surface of the at least one aperture in the spring retains the medical device in the housing by contacting a surface of the medical device when the spring is in the first position.

18. The grip member of claim 11 wherein the spring has a rectangular cross-section.

19. An apparatus for removeably supporting a medical device, the apparatus comprising:
a grip formed as a generally cylindrical structure, wherein the grip includes a cavity formed therein, the grip having a first aperture forming an exit from the cavity and a second aperture forming an exit from the cavity; and
a spring having a rectangular cross-section disposed in the cavity in a compressed state, the spring having a first end retained in the cavity and a second end extending through the first aperture, the spring having a first position to retain a medical device inserted into the cavity in the grip and a second position to allow the medical device inserted into the cavity to be released from the grip, the second end of the spring further comprising a button to allow the user to transfer the spring from the first position to the second position,
wherein the medical device is inserted through at least one aperture in the spring and held in the grip when the spring is in the first position by a top surface of the at least one aperture contacting a surface of the medical device.

20. The apparatus of claim 19 wherein the spring protrudes partially from the grip.
